(19) United States
(12) Patent Application Publication
(10) Pub. No.: US 2021/0324620 A1
(43) Pub. Date: Oct. 21, 2021

(54) ANTI-BACKFLOW DEVICE AND BIDET

(71) Applicant: Liang Peng, Pingxiang (CN)

(72) Inventor: Liang Peng, Pingxiang (CN)

(21) Appl. No.: 16/920,420

(22) Filed: Jul. 3, 2020

(30) Foreign Application Priority Data
Apr. 20, 2020 (CN) 202010312005.3

(51) Int. Cl. E03D 9/08; B05B 1/30; B05B 15/50

(52) U.S. Cl. CPC E03D 9/08; B05B 15/50; B05B 1/3013

(57) ABSTRACT

An anti-backflow device and a bidet are provided. The anti-backflow device includes a housing, an anti-siphon member, and a non-return assembly. A top of a water-passing chamber of the housing is provided with a vent. A bottom of the water-passing chamber is provided with a water inlet. A side wall of the water-passing chamber is provided with a water outlet. A sealing sheet of the anti-siphon member is movable to block the vent. The non-return assembly allows water to flow through the water inlet in only one direction.

### BACKGROUND OF THE INVENTION

### 1. Field of the Invention

The present invention relates to a sanitary device, and more particularly to an anti-backflow device and a bidet.

### 2. Description of the Prior Art

In general, some water discharge devices (such as showers, bidets, etc.) may have residual water inside the devices after use. After a period of time, the residual water in the water discharge devices may deteriorate or breed bacteria. When the water supply pipeline generates a negative pressure and the water discharge device is not closed, a siphon phenomenon will occur, causing the residual water in the water discharge device to flow back to the water supply and pollute the water supply. In addition, due to external factors, the outlet end of the water discharge device may be immersed in the sewage. For example, the toilet bowl is clogged, and the nozzle of the bidet is inundated with the sewage in the toilet bowl. In this case, if there is a negative pressure in the water supply pipeline and the water discharge device is not closed, a siphon phenomenon will occur. As a result, the external sewage flows back to the water supply to pollute the water supply.

### SUMMARY OF THE INVENTION

The primary object of the present invention is to provide an anti-backflow device, which can prevent water from flowing back to pollute a water supply. The present invention further provides a bidet having the anti-backflow device.

In order to achieve the above object, the present invention adopts the following technical solutions:

According to one aspect of the present invention, an anti-backflow device is provided. The anti-backflow device comprises a housing, an anti-siphon member, and a non-return assembly. The housing is provided with a water inlet port and a water outlet port. The housing has a water-passing chamber therein. A top of the water-passing chamber is provided with a vent. A bottom of the water-passing chamber is provided with a water inlet communicating with the water inlet port. A side wall of the water-passing chamber is provided with a water outlet communicating with the water outlet port. The anti-siphon member is vertically movably fitted to the housing. The anti-siphon member includes a sealing sheet located below the vent. The sealing sheet is movable to block the vent. The non-return assembly includes a non-return valve core and a spring. The non-return valve core is vertically movably disposed in the water-passing chamber. The non-return valve core is movable to block the water inlet. The spring is fitted in the water-passing chamber. Upper and lower ends of the spring lean against the housing and the non-return valve core, respectively.

Preferably, the housing includes an outer housing, an inner housing, and an end cap. The outer housing is provided with the water inlet port and the water outlet port. A mounting chamber is formed inside the outer housing. A top of the mounting chamber is provided with a mounting opening. A bottom of the mounting chamber is provided with an entry communicating with the water inlet port. A side wall of the mounting chamber is provided with an exit communicating with the water outlet port. The end cap is hermetically mounted on the mounting opening. An upper chamber is formed inside the end cap. A top of the upper chamber is provided with the vent. A bottom of the upper chamber is provided with a through hole. The anti-siphon member is vertically movably fitted to the end cap. The inner housing is hermetically mounted in the mounting chamber. A lower chamber is formed inside the inner housing. A top of the lower chamber is provided with a perforation communicating with the through hole. The upper chamber communicates with the lower chamber to form the water-passing chamber. A bottom of the lower chamber is provided with the water inlet. The water inlet communicates with the entry. A side wall of the lower chamber is provided with the water outlet. The water outlet communicates with the exit. The water outlet is in communication with the perforation.

Preferably, the lower chamber of the inner housing is fitted with the non-return valve core of the non-return assembly. The non-return valve core is vertically movably disposed in the lower chamber. The upper end of the spring leans against an inner top wall of the lower chamber.

Preferably, the inner housing includes an upper cover and a lower cover that is detachably fitted to a bottom of the upper cover. The lower chamber is formed between the upper cover and the lower cover. The perforation of the lower chamber is formed on a top of the upper cover. The water outlet of the lower chamber is formed on a side wall of the upper cover. The water inlet of the lower chamber is formed on a bottom of the lower cover.

Preferably, an upper end of the anti-siphon member is provided with a locking block, and the locking block is movably pressed against an upper end surface of the end cap.

Preferably, a top of the outer housing is provided with at least two mounting portions. The mounting portions surround the mounting opening. Each mounting portion has an engaging groove. A lower portion of the end cap is fitted into the mounting opening. A side wall of the end cap is provided with a plurality of engaging blocks corresponding to the mounting portions respectively. The engaging blocks are rotatably engaged with the engaging grooves of the mounting portions, respectively.

Preferably, an end cap sealing ring is provided between the side wall of the lower portion of the end cap and an inner wall of the mounting opening.

Preferably, an inner housing sealing ring is provided between an outer wall of the inner housing and an inner wall of the mounting chamber, and the inner housing sealing ring is located below the water outlet.

Preferably, the non-return valve core includes a sealing cover and a sealing pad. The sealing pad is fitted to a bottom of the sealing cover. The sealing pad is movable to block the water inlet. The lower end of the spring leans against the sealing cover.

According to another aspect of the present invention, a bidet is provided. The bidet comprises a bidet body. The bidet body includes a water diversion valve and a nozzle assembly. The water diversion valve is fixed to the bidet body. The water diversion valve includes a water diversion valve body and a water diversion valve core. The water diversion valve body has an inlet end and at least two outlet ends. The water diversion valve core is fitted to the water diversion valve body and controls the inlet end of the water diversion valve body to communicate with or not to communicate with each outlet end. The nozzle assembly includes a plurality of nozzles. Each nozzle is fitted to the bidet body. Each outlet end of the water diversion valve is in communication with a corresponding one of the nozzles of the nozzle assembly through the foregoing anti-backflow device. The water inlet port of the anti-backflow device is in communication with the corresponding outlet end of the water diversion valve, and the water outlet port of the anti-backflow device is in communication with the corresponding nozzle of the nozzle assembly.

After adopting the above solution, the anti-backflow device of the present invention can prevent the water at the water outlet port from flowing back to the water inlet port through the anti-siphon member and the non-return assembly, thereby achieving the effect of preventing the backflow of the water flow and avoiding the pollution of the water supply caused by the backflow of the water flow. Moreover, each of the anti-siphon member and the non-return assembly of the present invention can independently achieve the effect of preventing the backflow of the water flow, so that the anti-backflow device of the present invention has high reliability of anti-backflow.

### BRIEF DESCRIPTION OF THE DRAWINGS

FIG. 1 is a perspective view of the anti-backflow device of the present invention;

FIG. 2 is an exploded view of the anti-backflow device of the present invention;

FIG. 3 is a first cross-sectional view of the anti-backflow device of the present invention, wherein there is water flowing into the water inlet port;

FIG. 4 is a second cross-sectional view of the anti-backflow device of the present invention, wherein there is no water flowing into the water inlet port;

FIG. 5 is a perspective view of the bidet of the present invention; and

FIG. 6 is a partial perspective view of the bidet of the present invention.

### DETAILED DESCRIPTION OF THE PREFERRED EMBODIMENTS

Embodiments of the present invention will now be described, by way of example only, with reference to the accompanying drawings.

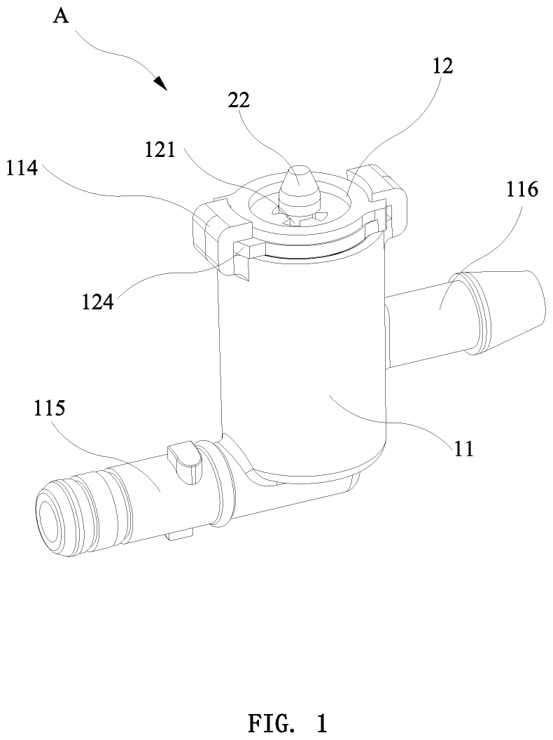

As shown in FIGS. 1 to 4, the present invention discloses an anti-backflow device A, comprising a housing 1, an anti-siphon member 2, and a non-return assembly 3. The housing 1 is provided with a water inlet port 115 and a water outlet port 116. The housing 1 has a water-passing chamber 100 therein. The top of the water-passing chamber 100 is provided with a vent 121, and the bottom of the water-passing chamber 100 is provided with a water inlet 132 communicating with the water inlet port 115. The side wall of the water-passing chamber 100 is provided with a water outlet 133 communicating with the water outlet port 116. The anti-siphon member 2 is vertically movably fitted to the housing 1. The anti-siphon member 2 includes a sealing sheet 21 located below the vent 121. The sealing sheet 21 is movable to block the vent 121. The non-return assembly 3 includes a non-return valve core 31 and a spring 32. The non-return valve core 31 is vertically movably disposed in the water-passing chamber 100. The non-return valve core 31 is movable to block the water inlet 132. The spring 32 is fitted in the water-passing chamber 100. Upper and lower ends of the spring 32 lean against the housing 1 and the non-return valve core 31 respectively, so as to drive the non-return valve 31 to block the water inlet 132.

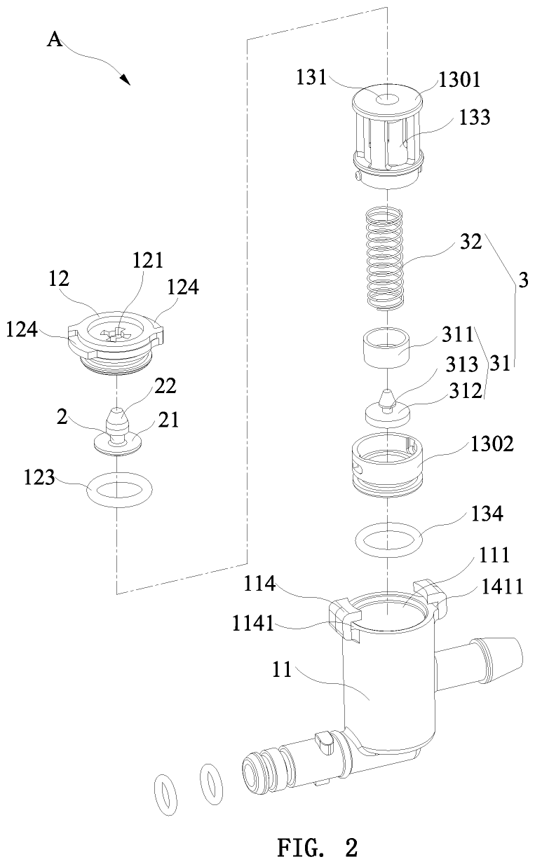

As shown in FIGS. 1 to 4, the housing 1 may include an outer housing 11, an end cap 12, and an inner housing 13. The outer housing 11 is provided with the water inlet port 115 and the water outlet port 116. A mounting chamber 110 is formed inside the outer housing 11. The top of the mounting chamber 110 is provided with a mounting opening 111. The bottom of the mounting chamber 110 is provided with an entry 112 communicating with the water inlet port 115. The side wall of the mounting chamber 110 is provided with an exit 113 communicating with the water outlet port 116. The end cap 12 is hermetically mounted on the mounting opening 111. An upper chamber 120 is formed inside the end cap 12. The top of the upper chamber 120 is provided with the vent 121. The bottom of the upper chamber 120 is provided with a through hole 122. The inner housing 13 is hermetically mounted in the mounting chamber 110. A lower chamber 130 is formed inside the inner housing 13. The top of the lower chamber 130 is provided with a perforation 131 communicating with the through hole 122, so that the upper chamber 120 communicates with the lower chamber 130 to form the water-passing chamber 100. The bottom of the lower chamber 130 is provided with the water inlet 132. The water inlet 132 communicates with the entry 112. The side wall of the lower chamber 130 is provided with the water outlet 133. The water outlet 133 communicates with the exit 113. The water outlet 133 is in communication with the perforation 131 so that outside air can enter the water outlet 133 and the exit 113 through the vent 121. As shown in FIGS. 1 to 4, the top of the outer housing 11 is provided with at least two mounting portions 114. The mounting portions 114 surround the mounting opening 111. Each mounting portion 114 has an engaging groove 1141. The lower portion of the end cap 12 is fitted into the mounting opening 111, and an end cap sealing ring 123 is provided between the side wall of the lower portion of the end cap 12 and the inner wall of the mounting opening 111, so that the lower portion of the end cap 12 is hermetically fitted into the mounting opening 111. The side wall of the end cap 12 is provided with a plurality of engaging blocks 124 corresponding to the mounting portions 114, respectively. The engaging blocks 124 are rotatably engaged with the engaging grooves 1141 of the mounting portions 114 respectively to prevent the lower portion of the end cap 12 from coming out of the mounting opening 111. As shown in FIGS. 2 to 4, an inner housing sealing ring 134 is provided between the outer wall of the inner housing 13 and the inner wall of the mounting chamber 110, so that the inner housing 14 is hermetically fitted in the mounting chamber 110. The inner housing sealing ring 134 is located below the water outlet 133. As shown in FIGS. 2 to 4, the inner housing 13 includes an upper cover 1301 and a lower cover 1302 that is detachably fitted to the bottom of the upper cover 1301. The lower chamber 130 is formed between the upper cover 1301 and the lower cover 1302. The perforation 131 of the lower chamber 130 is formed on the top of the upper cover 1301. The water outlet 133 of the lower chamber 130 is formed on the side wall of the upper cover 1301. The water inlet 132 of the lower chamber 130 is formed on the bottom of the lower cover 1302. It should be noted that the housing 1 of the present invention is not limited to being composed of the outer housing 11, the end cap 12 and the inner housing 13. The housing 1 may be formed by joining two half housings. The water-passing chamber 100 is formed between the two half housings.

As shown in FIGS. 2 to 4, the anti-siphon member 2 is vertically movably fitted to the end cap 12 of the housing 1. The upper end of the anti-siphon member 2 is provided with a locking block 22. The locking block 22 is movably pressed against the upper end surface of the end cap 12 to prevent the anti-siphon member 2 from being separated from the end cap 12. The middle portion of the anti-siphon member 2 is vertically movably disposed in the vent 121 of the end cap 12, and a gap is defined between the middle portion of the anti-siphon member 2 and the inner wall of the vent 121 of the end cap 12 to ensure air circulation.

As shown in FIGS. 2 to 4, the lower chamber 130 of the inner housing 13 is fitted with the non-return valve core 31 of the non-return assembly 3. The non-return valve core 31 is vertically movably disposed in the lower chamber 130 of the inner housing 13. The upper end and the lower end of the spring 32 lean against the inner top wall of the lower chamber 130 and the non-return valve core 31 respectively, so that the spring 32 can drive the non-return valve core 31 to block the water inlet 132. As shown in FIGS. 2 to 4, the non-return valve core 31 may include a sealing cover 311 and a sealing pad 312. The sealing pad 312 is fitted to the bottom of the sealing cover 311, and the sealing pad 312 is movable to block the water inlet 132. The lower end of the spring 32 leans against the sealing cover 311, thereby providing a downward force to the sealing cover 311 and the sealing pad 312. A central hole 3111 is defined in the sealing cover 311. A connecting post 313 is connected to the upper end surface of the sealing pad 312. The connecting post 313 passes through the central hole 3111 in a bottom-up direction. The top of the connecting post 3121 is formed with a limiting block 3131 to be engaged with the sealing cover 311 to prevent the sealing pad 312 from falling off.

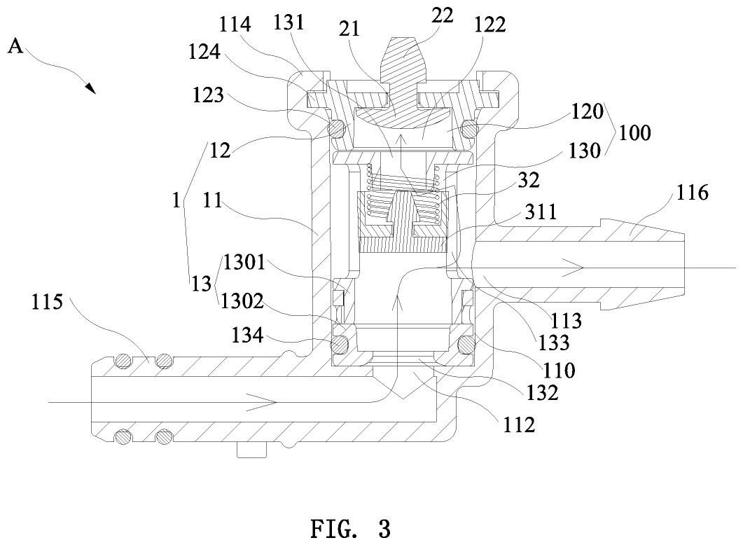

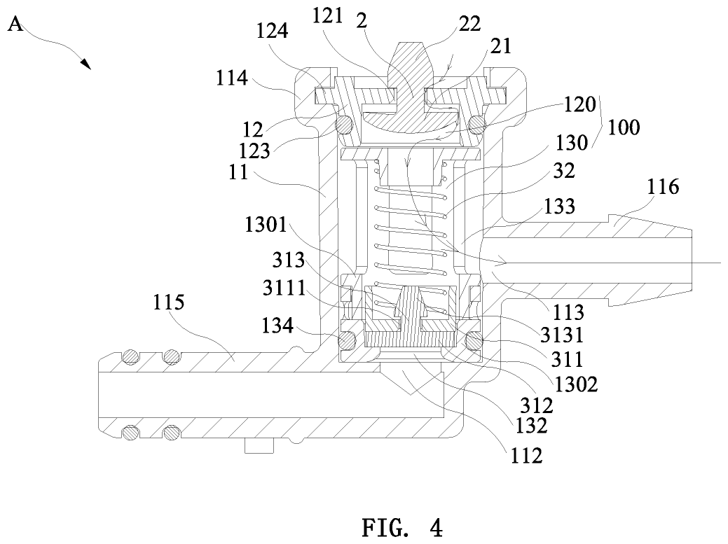

The working principle of the anti-backflow device A according to the present invention is described below. As shown in FIG. 3, when water flows into the water inlet port 115, the water will impact the non-return valve core 31 and drive the non-return valve core 31 to move up. The water inlet 132 is opened and the spring 32 is compressed, so that the water flows into the water-passing chamber 100. The water flowing into the water-passing chamber 100 will impact the sealing sheet 21 of the anti-siphon member 2 to move the sealing sheet 21 upward so as to block the vent 121, thereby preventing the water in the water-passing chamber 100 from leaking via the vent 121. At the same time, the water flowing into the water-passing chamber 100 flows to the water outlet port 116 through the water outlet 133 to be discharged. As shown in FIG. 4, when there is no water flowing into the water inlet port 115 of the present invention, the non-return valve core 31 is no longer impacted by the water, and the spring 32 is returned to move the non-return valve core 31 downward to block the water inlet 132. In this way, even if siphon negative pressure is generated at the water inlet port 115, the water at the water outlet port 116 will not flow back to the water inlet port 115. In addition, when there is no water flowing into the water inlet port 115 and the water in the water-passing chamber 100 drops below the exit 113, the anti-siphon member 2 moves down under its own gravity to open the vent 121, so that the exit 113 is in communication with the outside atmosphere through the vent 121, thereby avoiding the occurrence of siphoning, so as to prevent the water at the water outlet port 116 from flowing back to the water inlet port 115 due to the negative pressure of the siphon.

In summary, the anti-backflow device A of the present invention can prevent the water at the water outlet port 116 from flowing back to the water inlet port 115 through the anti-siphon member 2 and the non-return assembly 3, thereby achieving the effect of preventing the backflow of the water flow and avoiding the pollution of the water supply caused by the backflow of the water flow. Moreover, each of the anti-siphon member 2 and the non-return assembly 3 of the present invention can independently achieve the effect of preventing the backflow of the water flow, so that the anti-backflow device A of the present invention has high reliability of anti-backflow.

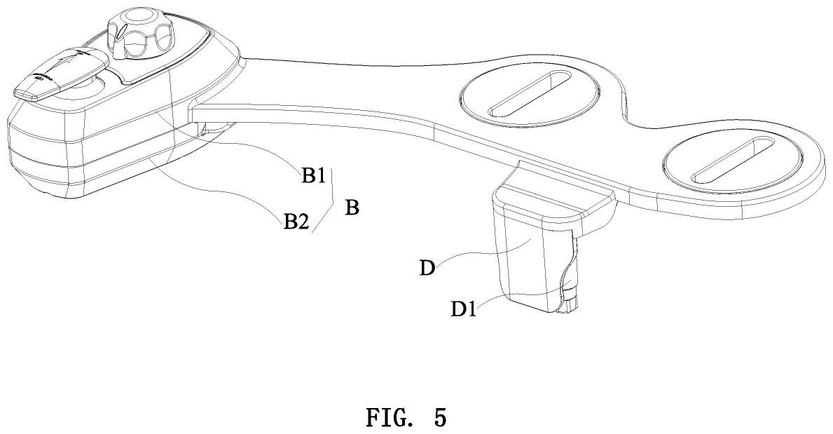

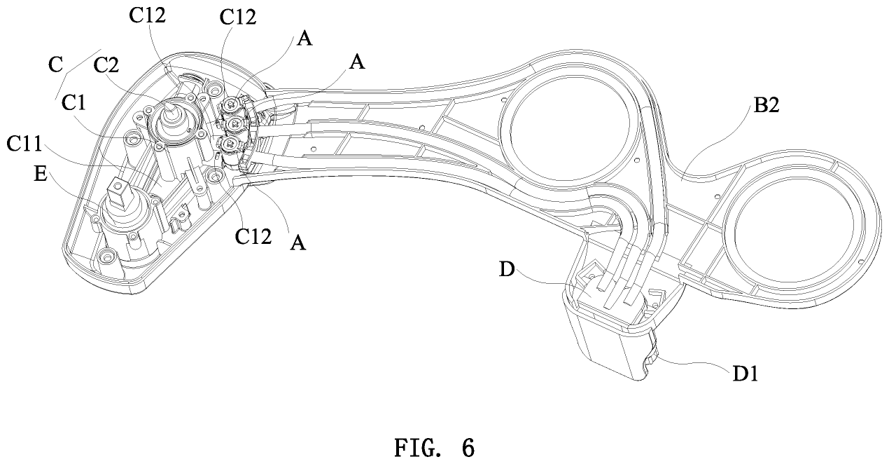

As shown in FIG. 5 and FIG. 6, the present invention also discloses a bidet, comprising a bidet body B. The bidet body B includes a water diversion valve C and a nozzle assembly D. The water diversion valve C is fixed to the bidet body A. The water diversion valve C includes a water diversion valve body C1 and a water diversion valve core C2. The water diversion valve body C1 has an inlet end C11 and at least two outlet ends C12. The water diversion valve core C2 is fitted onto the water diversion valve body C1 and controls the inlet end C11 of the water diversion valve body C1 to communicate with or not to communicate with each outlet end C12. The nozzle assembly D includes a plurality of nozzles D1 Each nozzle D1 is fitted to the bidet body B. Each outlet end C12 of the water diversion valve C is in communication with each nozzle D1 of the nozzle assembly D through the above-mentioned anti-backflow device A. The water inlet port 115 of the anti-backflow device A is in communication with the outlet end C12 of the water diversion valve C. The water outlet port 116 of the anti-backflow device A is in communication with the nozzle D1 of the nozzle assembly D. The anti-backflow device A can prevent the backflow problem of the bidet, thereby ensuring the cleanness of the water supply. The bidet body B is composed of an upper body B1 and a lower body B2 that are joined together. The water diversion valve C is locked on the bidet body B by screws. The outlet end C12 of the water diversion valve C is directly connected to the water inlet port 115 of the anti-backflow device A, while the nozzle D1 is connected to the water outlet port 116 of the anti-backflow device A through a hose.

As shown in FIG. 6, the water diversion valve C may be a three-way water diversion valve, that is, the water diversion valve body C1 has three outlet ends C12. The nozzle assembly D has three nozzles, defined as a first cleaning nozzle, a second cleaning nozzle, and a self-cleaning nozzle. The first cleaning nozzle and the second cleaning nozzle are arranged side by side. The self-cleaning nozzle is arranged above the first cleaning nozzle and the second cleaning nozzle. The first cleaning nozzle and the second cleaning nozzle are configured to clean the user. The self-cleaning nozzle is configured to clean the first cleaning nozzle and the second cleaning nozzle. The three outlet ends C12 of the water diversion valve body C1 are respectively connected to the first cleaning nozzle, the second cleaning nozzle and the self-cleaning nozzle through the anti-backflow device A. As shown in FIG. 6, in addition, the bidet body B is provided with a water mixing valve E. The mixed water outlet end of the water mixing valve E is in communication with the inlet end C11 of the water diversion valve C. The temperature of water discharged from the nozzle D1 can be controlled by the water mixing valve E.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. An anti-backflow device, comprising a housing, an anti-siphon member, and a non-return assembly;
the housing being provided with a water inlet port and a water outlet port, the housing having a water-passing chamber therein, a top of the water-passing chamber being provided with a vent, a bottom of the water-passing chamber being provided with a water inlet communicating with the water inlet port, a side wall of the water-passing chamber being provided with a water outlet communicating with the water outlet port;
the anti-siphon member being vertically movably fitted to the housing, the anti-siphon member including a sealing sheet located below the vent, the sealing sheet being movable to block the vent;
the non-return assembly including a non-return valve core and a spring, the non-return valve core being vertically movably disposed in the water-passing chamber, the non-return valve core being movable to block the water inlet, the spring being fitted in the water-passing chamber, upper and lower ends of the spring leaning against the housing and the non-return valve core, respectively.

2. The anti-backflow device as claimed in claim 1, wherein the housing includes an outer housing, an inner housing, and an end cap;
the outer housing is provided with the water inlet port and the water outlet port, a mounting chamber is formed inside the outer housing, a top of the mounting chamber is provided with a mounting opening, a bottom of the mounting chamber is provided with an entry communicating with the water inlet port, a side wall of the mounting chamber is provided with an exit communicating with the water outlet port;
the end cap is hermetically mounted on the mounting opening, an upper chamber is formed inside the end cap; a top of the upper chamber is provided with the vent, a bottom of the upper chamber is provided with a through hole; the anti-siphon member is vertically movably fitted to the end cap;
the inner housing is hermetically mounted in the mounting chamber, a lower chamber is formed inside the inner housing; a top of the lower chamber is provided with a perforation communicating with the through hole, the upper chamber communicates with the lower chamber to form the water-passing chamber; a bottom of the lower chamber is provided with the water inlet, the water inlet communicates with the entry; a side wall of the lower chamber is provided with the water outlet, the water outlet communicates with the exit, and the water outlet is in communication with the perforation.

3. The anti-backflow device as claimed in claim 2, wherein the lower chamber of the inner housing is fitted with the non-return valve core of the non-return assembly, the non-return valve core is vertically movably disposed in the lower chamber; the upper end of the spring leans against an inner top wall of the lower chamber.

4. The anti-backflow device as claimed in claim 3, wherein the inner housing includes an upper cover and a lower cover that is detachably fitted to a bottom of the upper cover, the lower chamber is formed between the upper cover and the lower cover, the perforation of the lower chamber is formed on a top of the upper cover, the water outlet of the lower chamber is formed on a side wall of the upper cover, and the water inlet of the lower chamber is formed on a bottom of the lower cover.

5. The anti-backflow device as claimed in claim 2, wherein an upper end of the anti-siphon member is provided with a locking block, and the locking block is movably pressed against an upper end surface of the end cap.

6. The anti-backflow device as claimed in claim 2, wherein a top of the outer housing is provided with at least two mounting portions, the mounting portions surround the mounting opening, each mounting portion has an engaging groove; a lower portion of the end cap is fitted into the mounting opening, a side wall of the end cap is provided with a plurality of engaging blocks corresponding to the mounting portions respectively, and the engaging blocks are rotatably engaged with the engaging grooves of the mounting portions, respectively.

7. The anti-backflow device as claimed in claim 6, wherein an end cap sealing ring is provided between the side wall of the lower portion of the end cap and an inner wall of the mounting opening.

8. The anti-backflow device as claimed in claim 2, wherein an inner housing sealing ring is provided between an outer wall of the inner housing and an inner wall of the mounting chamber, and the inner housing sealing ring is located below the water outlet.

9. The anti-backflow device as claimed in claim 1, wherein the non-return valve core includes a sealing cover and a sealing pad, the sealing pad is fitted to a bottom of the sealing cover, the sealing pad is movable to block the water inlet; and the lower end of the spring leans against the sealing cover.

10. The anti-backflow device as claimed in claim 2, wherein the non-return valve core includes a sealing cover and a sealing pad, the sealing pad is fitted to a bottom of the sealing cover, the sealing pad is movable to block the water inlet; and the lower end of the spring leans against the sealing cover.

11. A bidet, comprising a bidet body, the bidet body including a water diversion valve and a nozzle assembly; the water diversion valve being fixed to the bidet body, the water diversion valve including a water diversion valve body and a water diversion valve core; the water diversion valve body having an inlet end and at least two outlet ends, the water diversion valve core being fitted to the water diversion valve body and controlling the inlet end of the water diversion valve body to communicate with or not to communicate with each outlet end; the nozzle assembly including a plurality of nozzles, each nozzle being fitted to the bidet body;
each outlet end of the water diversion valve being in communication with a corresponding one of the nozzles of the nozzle assembly through the anti-backflow device as claimed in claim 1, wherein the water inlet port of the anti-backflow device is in communication with the corresponding outlet end of the water diversion valve, and the water outlet port of the anti-backflow device is in communication with the corresponding nozzle of the nozzle assembly.
